(19) United States
(12) Patent Application Publication
(10) Pub. No.: US 2012/0105836 A1
(43) Pub. Date: May 3, 2012

(54) APPARATUS FOR MEASURING OPTICAL PROPERTIES OF LED PACKAGE

(75) Inventors: Sang Bok YOON, Suwon (KR); Hae Yong EOM, Suwon (KR); Choong Hwan KWON, Icheon (KR)

(73) Assignee: SAMSUNG LED CO., LTD., Suwon (KR)

(21) Appl. No.: 13/286,601

(22) Filed: Nov. 1, 2011

(30) Foreign Application Priority Data
Nov. 1, 2010 (KR) 10-2010-0107739

(51) Int. Cl. G01N 21/01

(52) U.S. Cl. 356/244

(57) ABSTRACT

An apparatus for measuring the optical properties of an LED package includes: a light detection unit detecting light output from a plurality of LED packages of an LED package array in order to measure the optical properties of each of the LED packages; a mounting unit fixing the LED package array thereon when the optical properties thereof are measured; and a voltage application unit applying a driving voltage to the individual LED packages in the LED package array when the optical properties of the LED packages are measured.

### CROSS-REFERENCE TO RELATED APPLICATIONS

This application claims the priority of Korean Patent Application No. 10-2010-0107739 filed on Nov. 1, 2010, in the Korean Intellectual Property Office, the disclosure of which is incorporated herein by reference.

### BACKGROUND OF THE INVENTION

1. Field of the Invention

The present invention relates to an apparatus for measuring optical characteristics and, more particularly, to an apparatus for measuring the optical characteristics of a light emitting diode (LED) package.

2. Description of the Related Art

In general, an LED package is implemented by coating a light-transmissive resin (a sealing agent, a sealing material, or a sealant) to protect a package main body, an LED chip mounted on a package substrate and an electrode connection portion (e.g., a bump ball) or a bonding wire. The light-transmissive resin in use may be a simple transparent material without phosphors included therein, or a material including phosphors, according to the color of output light of the LED package desired to be implemented. The color of light output from the LED package may vary depending on various phosphors and resins used therein (e.g., a silicon resin, and the like). The LED package may be used as a white light emitting apparatus for illumination or a white light emitting apparatus in a backlight unit.

In a general LED package fabrication process, a die bonding process is performed to mount an LED chip on a mounting area of a package main body or a package substrate and fix the LED chip, and then, a wire bonding process for connecting electrodes is performed to mount the LED chip on the package main body or the package substrate. In this case, a plurality of LED chips may set in an array on a plurality of mounting areas of the package main body. Thereafter, a light-transmissive resin (e.g., a silicon resin including phosphor, or the like) is dispensed on the LED chips and then cured (or hardened). After the light-transmissive resin is hardened, a singulation process is performed to separate the LED chip array on the package main body into individual LED packages, and then, the optical properties of the individual LED packages are measured. However, the measurement of the optical properties of the separated individual LED packages by using existing optical properties measurement apparatuses is ineffective, and there is a limitation in improving a production yield or the characteristics of the LED packages with the system for measuring the optical properties of the individual LED packages.

### SUMMARY OF THE INVENTION

An aspect of the present invention provides an apparatus for effectively measuring the optical properties of an LED package to thus increase a process yield and be advantageous for the enhancement of the characteristics thereof.

According to an aspect of the present invention, there is provided an apparatus for measuring the optical properties of an LED package including: a light detection unit detecting light output from a plurality of LED packages of an LED package array in order to measure the optical properties of each of the LED packages; a mounting unit fixing the LED package array thereon when the optical properties thereof are measured; and a voltage application unit applying a driving voltage to the individual LED packages in the LED package array when the optical properties of the LED packages are measured.

The LED package array may be an LED package array in a lead frame state in which the plurality of LED packages are installed to be arranged on a lead frame.

The light detection unit may be horizontally moved to measure the optical properties of the LED packages in the LED package array, while changing the LED packages as measurement targets.

The light detection unit may be horizontally moved in two directions along the LED packages in the LED package array.

The voltage application unit may be horizontally moved to apply voltage to the LED packages in the LED package array, while changing the LED packages as voltage application targets.

The voltage application unit may include probe pins for applying a driving voltage to each of the LED packages in the LED package array.

The light detection unit may simultaneously detect light output from two or more LED packages in order to simultaneously measure the optical properties of the two or more LED packages in the LED package array.

The voltage application unit may simultaneously apply a driving voltage to two or more LED packages in order to simultaneously measure the optical properties of the two or more LED packages in the LED package array.

The voltage application unit comprises a plurality of probe pin sets, and each of the probe pin sets may apply a driving voltage to one or more LED packages and separately operate.

The LED packages may be arranged in rows and columns in the LED package array, and the voltage application unit may simultaneously or sequentially apply driving voltages to the LED packages of one row, and then simultaneously or sequentially apply driving voltages to the LED packages of the next row.

The respective LED packages of the LED package array may be LED packages in a state in which a light-transmissive resin is dispensed thereon, and the light detection unit may detect the optical properties of light output from the LED packages in the light-transmission resin dispensed state.

The respective LED packages of the LED package array may be LED packages in a state in which a light-transmissive resin is not dispensed thereon, and the light detection unit may detect the optical properties of light output from the LED packages in the state in which the light-transmissive resin is not dispensed thereon.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating an apparatus for measuring optical properties of LED packages according to an exemplary embodiment of the present invention;

FIG. 2 is a view illustrating the apparatus for measuring optical properties of the LED packages of FIG. 1 viewed in a different direction; and

FIG. 3 is a plan view showing an example of an LED package array in a lead frame state in which optical properties of the LED packages are measured by the apparatus for measuring optical properties of LED packages according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

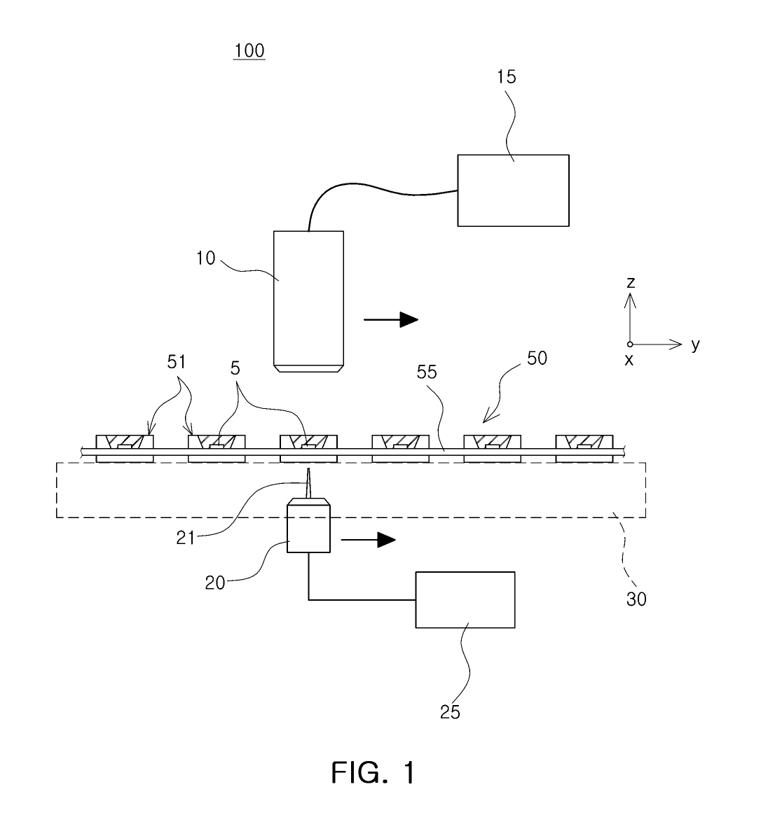

FIG. 1 is a view illustrating an apparatus for measuring the optical properties of LED packages according to an exemplary embodiment of the present invention. With reference to FIG. 1, the apparatus for measuring optical properties (referred to as an ‘optical properties measurement apparatus’) includes a light detection unit 10, a mounting unit 30, and a voltage application unit 20. Unlike existing measurement apparatuses, the optical properties measurement apparatus 100 measures optical properties of LED packages 51 in an LED package array 50 in a state in which the LED packages 51 are separated into individual LED packages (namely, before a singulation process of separating the LED packages into individual LED packages is performed). For example, as shown in FIG. 1, the LED package array 50 may be an LED package array in a lead frame state in which the plurality of LED packages are installed to be arranged on a lead frame 50 However, without being limited thereto, the present invention can be applicable to an LED package array not using a lead frame (e.g., a ceramic package array having a conductive pattern therein). An LED chip 5 is mounted on each of the LED packages 51 in the LED package array 50.

The light detection unit 10 detects light output from the LED packages 51 in order to measure the optical properties of the respective LED packages 51 in the LED package array 50. The light detection unit 10 may include, for example, a photosensitive sensor having a photodiode. The light detection unit 10 may constitute a detection measurement means for detecting and measuring optical properties along with a measurement unit 15. The measurement unit 15 measures and analyzes the optical properties of light detected by the light detection unit 10 and may include, for example, a spectrum analyzer, or the like. The measurement unit 15 may include a calculation processing device, a memory device, or the like, in order to measure the optical properties of light output from the LED packages detected by the light detection unit 10.

The mounting unit 30 serves to fix the LED package array 50 thereon in measuring optical properties through the light detection unit 10. For example, the mounting unit 30 may fix a lead frame 55 by using a clamp (not shown), or the like. The mounting unit 30 may include transportation such as a rail, or the like, for transporting the entirety of the LED package array 50 to a different space or place in order to accommodate a different LED package array in standby, when the detection of the optical properties of the entirety of the LED package array 50 is completed. The voltage application unit 20 is connected to a power source 25 or a source meter to apply a driving voltage to an LED package as a measurement target through a probe pin 21.

According to the present exemplary embodiment, the light detection unit 10 may move horizontally to measure the optical properties of each of the LED packages in the LED package array 50, while changing the measurement targets (i.e., the LED packages 51). The voltage application unit 20 may also move horizontally to apply a driving voltage to each of the LED packages in the LED package array 50, while changing the LED packages 51 as voltage application targets.

For example, the voltage application unit 20 may move in a y direction to sequentially apply voltage to each of the LED packages 51 in the LED package array 50, and the light detection unit 10 may also move in the y direction to sequentially detect light output from each of the LED packages in the LED package array 50. The voltage application unit 20 or the light detection unit 10 may also move in an x direction, as well as in the y direction, to change the voltage application targets or the measurement targets. Besides, the voltage application unit 20 or the light detection unit 10 may move in other directions to change the LED packages as measurement targets.

In an exemplary embodiment, the voltage application unit 20 may simultaneously apply voltage to two or more LED packages adjacent in the LED package array 50 and then also simultaneously apply voltage to the next two or more LED packages, to thus measure the optical properties of all the LED packages in the LED package array 50. In this case, the light detection unit 10 may simultaneously detect light output from the two or more LED packages 51 in order to simultaneously measure the optical properties of two or more LED packages 51 in the LED package array 50. In this case, the light detection unit 10 may include two or more light receiving units. Alternatively, the voltage application unit 20 may simultaneously apply voltage to two or more LED packages, while the light detection unit 10 may sequentially detect light output from each of the LED packages.

In an exemplary embodiment, the voltage application unit 20 may simultaneously apply a driving voltage to all the LED packages 51 in the LED package array 50. In this case, the light detection unit 10 may sequentially detect light output from the respective LED packages or simultaneously detect light output from all the LED packages 51 in the LED package array 50.

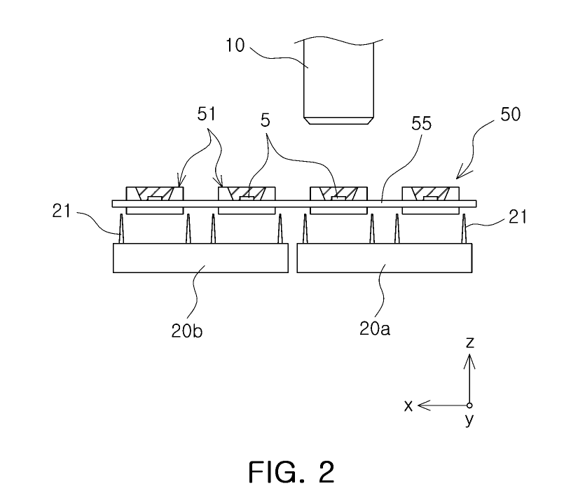

FIG. 2 is a view illustrating the optical properties measurement apparatus 100 of FIG. 1 viewed in the y direction. With reference to FIG. 2, the voltage application unit 20 includes a set of probe pins 20a and 20b. The probe pins 20a and 20b may include four probe pins 21, respectively, in order to apply a driving voltage to two LED packages 51. In order to drive one LED package 51, two probe pins, namely, a positive polarity probe pin brought into contact with a positive electrode of the LED package and a negative polarity probe pin brought into contact with a negative electrode of the LED package, are required. Thus, the respective probe pins 20a and 20b, each having four probe pints 21, can apply a driving voltage to the two LED packages (sequentially or simultaneously).

As shown in FIG. 2, when the LED packages 51 are arranged in four rows in the LED package array 50, the respective probe pins 20a and 20b may apply a driving voltage to two LED packages 51 and may individually operate. The probe pin set 20a disposed at the right side in FIG. 2 may apply a driving voltage to the LED packages of the right two rows, while the probe pins 20b disposed at the left side may apply a driving voltage to the LED packages of the left two rows. The probe pins 20a and 20b may simultaneously apply driving voltage or may separately or sequentially apply driving voltages. For example, the right probe pins 20a may apply driving voltages to the LED packages of the right two rows, and thereafter, when the left probe pins 20b apply driving voltages to the LED packages of the left two rows, the right probe pins 20a may move to be in standby (in the y direction) below the LED packages of the next row (e.g., LED packages at a front side in the y direction).

In the foregoing exemplary embodiment, the voltage application unit 20 includes the sets of two probe pins and each set of the probe pins is configured to apply a driving voltage to two LED packages. However, the present invention is not limited thereto, and the voltage application unit 20 may include a set of three or more probe pins, and each of the probe pins may be configured to apply a driving voltage to one or more LED packages. Alternatively, the voltage application unit 20 may include a single probe pin.

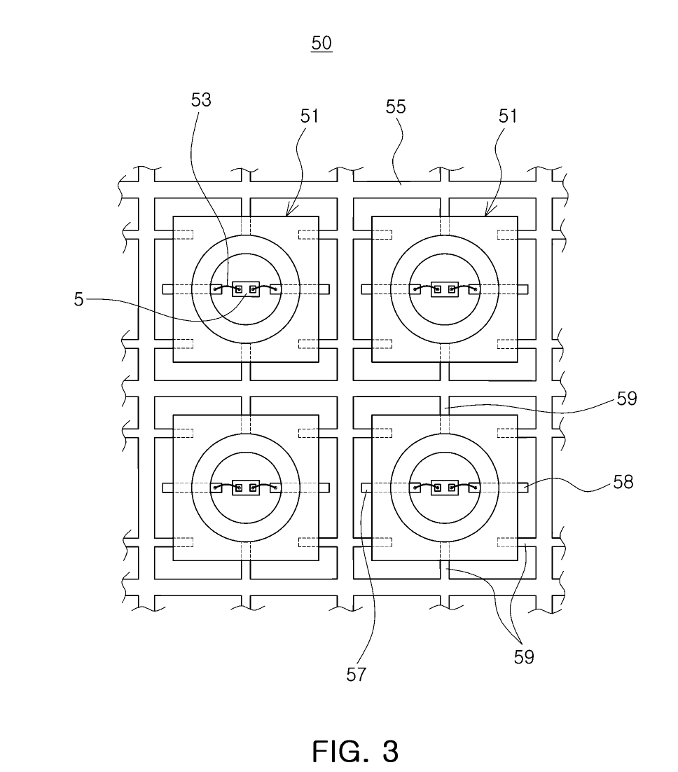

FIG. 3 is a plan view showing an example of an LED package array in which optical properties of the LED packages are measured by the apparatus for measuring optical properties of LED packages as described above. As shown in FIG. 3, the LED package array 50 may be a package array in a lead frame state in which the plurality of LED packages 51 are installed on the lead frame 55. The LED packages 51 may be arranged in rows and columns in the LED package array 50. In order to apply voltage to each of the LED packages in the LED package array in the lead frame state to easily measure the optical properties of each of the LED packages, positive electrodes 57 and negative electrodes 58 of the LED packages 51 are electrically separated. The lead frame 55 includes a package support part 59 insertedly fixed to a package main body or a substrate of each of the LED packages 51. The LED chip 5 mounted in each of the LED packages 51 may be electrically connected to the package electrodes 57 and 58 through, for example, bonding wires 53.

In the LED package array in which the plurality of LED packages in rows and columns, the foregoing voltage application unit 20 may simultaneously or sequentially apply a driving voltage to the LED packages of a row and then simultaneously or sequentially apply a driving voltage to the LED packages of the next row.

The foregoing optical properties measurement apparatus can measure the optical properties of the LED package 51 on which a light-transmissive resin is dispensed (e.g., on which a dispensing process has been completed). Besides, the foregoing optical properties measurement apparatus can also detect optical properties of the LED package 51 on which the light-transmissive resin has not been dispensed yet. The respective LED packages 51 in the LED package array 50 may be LED packages on which the light-transmissive resin has been dispensed or the dispensing process has been performed, and the light detection unit 10 may detect the optical properties of light output from the LED packages on which the light-transmissive resin has been disposed. Alternatively, the respective LED packages 51 in the LED package array 50 may be LED packages on which the light-transmissive resin has not been dispensed yet, and the light detection unit 10 may detect the optical properties of light output from the LED packages on which the light-transmissive resin has not been disposed.

As set forth above, according to exemplary embodiments of the invention, because optical properties of the respective LED packages in the LED package array are measured before a singulation process for separating the individual LED packages, the efficiency of the process of measuring the optical properties of the LED packages can be enhanced, a production yield of the LED packages can be increased, and the characteristics of the LED packages can be improved. In particular, the efficiency of measuring optical properties of the LED packages can be maximized by using the light detection unit and the voltage application unit movable in a horizontal direction to sequentially change the measurement targets.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for measuring optical properties of an LED package, the apparatus comprising:
a light detection unit detecting light output from a plurality of LED packages of an LED package array in order to measure the optical properties of each of the LED packages;
a mounting unit fixing the LED package array thereon when the optical properties thereof are measured; and
a voltage application unit applying a driving voltage to the individual LED packages in the LED package array when the optical properties of the LED packages are measured.

2. The apparatus of claim 1, wherein the LED package array is an LED package array in a lead frame state in which the plurality of LED packages are installed to be arranged on a lead frame.

3. The apparatus of claim 1, wherein the light detection unit is horizontally moved to measure the optical properties of the LED packages in the LED package array, while changing the LED packages as measurement targets.

4. The apparatus of claim 1, wherein the light detection unit is horizontally moved in two directions along the LED packages in the LED package array.

5. The apparatus of claim 1, wherein the voltage application unit is horizontally moved to apply voltage to the LED packages in the LED package array, while changing the LED packages as voltage application targets.

6. The apparatus of claim 1, wherein the voltage application unit comprises probe pins for applying a driving voltage to each of the LED packages in the LED package array.

7. The apparatus of claim 1, wherein the light detection unit simultaneously detects light output from two or more LED packages in order to simultaneously measure the optical properties of the two or more LED packages in the LED package array.

8. The apparatus of claim 1, wherein the voltage application unit simultaneously applies a driving voltage to two or more LED packages in order to simultaneously measure the optical properties of the two or more LED packages in the LED package array.

9. The apparatus of claim 1, wherein the voltage application unit comprises a plurality of probe pin sets, and each of the probe pin sets applies a driving voltage to one or more LED packages and separately operate.

10. The apparatus of claim 1, wherein the LED packages are arranged in rows and columns in the LED package array, and the voltage application unit simultaneously or sequentially applies driving voltages to the LED packages of one row, and then simultaneously or sequentially applies driving voltages to the LED packages of the next row.

11. The apparatus of claim 1, wherein the respective LED packages of the LED package array are LED packages in a state in which a light-transmissive resin is dispensed thereon, and the light detection unit may detect the optical properties of light output from the LED packages in the light-transmission resin dispensed state.

12. The apparatus of claim 1, wherein the respective LED packages of the LED package array are LED packages in a state in which a light-transmissive resin has not dispensed thereto, and the light detection unit may detect the optical properties of light output from the LED packages in the state in which the light-transmissive resin is not dispensed.
